(19) United States
(12) Patent Application Publication
(10) Pub. No.: US 2013/0110865 A1
(43) Pub. Date: May 2, 2013

(54) Image Endorsements

(71) Applicants: Arcot J. Preetham, San Jose, CA (US); Myron Flickner, San Jose, CA (US); Xiaorui Gan, Santa Clara, CA (US); Gabriel Wolosin, San Mateo, CA (US)

(72) Inventors: Arcot J. Preetham, San Jose, CA (US); Myron Flickner, San Jose, CA (US); Xiaorui Gan, Santa Clara, CA (US); Gabriel Wolosin, San Mateo, CA (US)

(73) Assignee: Google Inc.

(21) Appl. No.: 13/283,347

(22) Filed: Oct. 27, 2011

(51) Int. Cl. G06F 17/30

(52) U.S. Cl. 707/769; 707/E17.019; 707/E17.014

(57) ABSTRACT

Methods, systems, and apparatus, including computer programs encoded on a computer storage medium, for processing image endorsements. In one aspect, a method includes receiving a search query from a user device of a user that belongs to a social affinity group; receiving image search results responsive to the search query, each image search result referencing a corresponding image resource and including a representative image of the image resource; identifying representative images of the image search results that each have an endorsement association with one or more of the users identified by the social affinity group; generating annotation data describing the endorsement association with at least one of the users identified by the social affinity group; and providing the annotation data to a user device for presentation with the representative image.

### BACKGROUND

This specification relates to information presentation.

The Internet provides access to a wide variety of resources. For example, digital image files, video and/or audio files, as well as web pages for particular subjects or particular news articles, are accessible over the Internet. A variety of search systems are available for finding particular resources accessible over the Internet. For example, digital images can be provided through an image search process in which keywords or other data can be processed to identify collections of digital images for requesting users.

The Internet also provides access to electronic social networks. An electronic social network (referred to as “social network”) provides functions that allow participants to interact by sharing information with other participants who share one or more social commonalities. Users of a social network are able to identify other users with whom they have a social relationship, e.g., a work relationship, a friend relationship, and the like. Once a social relationship has been identified, the users that are linked by the relationship constitute a “social affinity group.” The users typically are able to receive communications, status updates, and other notifications generated by other users within their social affinity group.

One type of communication that users can receive by means of their social affinity groups is an endorsement annotation. For example, some systems track “endorsements” of web pages by users and provide information describing the endorsements to other users that belong to the same social affinity group to which the endorsing users belong.

As used herein, an endorsement is a signal that a particular user approves of, prefers, or otherwise recommends particular content. Generally, an endorsement results from a positive interaction by the user. However, endorsements can include both positive endorsements, described above, and negative endorsements. A negative endorsement is a signal that a particular user disapproves of, does not prefer, or otherwise does not recommend particular content.

Tracking endorsements for web pages typically involves associating endorsement counts and identifiers of the endorsers with particular web pages. The association can be done by the website hosting the web page, or by a third party, e.g., a service that aggregates endorsements, a search system, etc. However, in the context of images, the tracking of endorsements is more complex. Typically, a particular image may be replicated at many different websites. This is especially so when the particular image is very popular—e.g., an iconic image, an image that is visually appealing to many different users, and so on. Furthermore, a particular webpage may include multiple images, and thus associating an endorsement with the webpage may result in ambiguous endorsements when the web page includes multiple images.

### SUMMARY

This specification describes technologies relating to annotating image search results of social interest to a user.

In general, one innovative aspect of the subject matter described in this specification can be embodied in methods that include the actions of receiving a search query from a user device of a user, the user belonging to a social affinity group, the social affinity group identifying a group of users and the user as a proper subset of users of a network; receiving image search results responsive to the search query, each image search result referencing a corresponding image resource that is determined to be responsive to the search query and including a representative image of the image resource, the representative image having a corresponding image identifier by which the representative image is indexed in a search system; identifying representative images of the image search results that each have an endorsement association with one or more of the users identified by the social affinity group; for each image search result that includes a representative image having an endorsement association with one or more of the users identified by the social affinity group, generating annotation data describing the endorsement association with at least one of the users identified by the social affinity group; and providing the annotation data to a user device for presentation with the representative image. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. Aggregating image endorsements at a representative image level facilitates the provisioning of a complete endorsement history with the representative image, thus providing each user with a complete endorsement history of an image with respect to the user's social affinity group(s). Furthermore, ambiguities that exist when an endorsement is associated only with a web page in which the image is hosted are resolved. Attribution of endorsements between the representative image and the underlying images that the representative image represents also allows for propagation of the endorsement history of the image (with respect to the user's social affinity group(s)) across multiple web sites and web pages, which, in turn, provides information to a user that a particular image may be of social interest to the user.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which image endorsements in image search results are provided.

FIGS. 2A-2C show an example user interface that includes an image with endorsement data and a control for endorsing the image.

FIG. 3 is a flowchart of an example process for processing an endorsement for an image.

FIG. 4 is a flowchart of an example process for providing annotations based on endorsements.

Like reference numbers and designations in the various drawings indicate like elements.

### DETAILED DESCRIPTION

Overview

A user searching for resources has social interests separate from the interests of a general population of users. In particular, the user may have similar interests with a very small subset of users in the general population of users. These similar interests may also vary among different subsets. For example, for a particular user, interests that are similar among the user and family members may differ from interests that are similar among the user and the user's co-workers.

As described above, any particular user accessing the Internet may have many different relationships with many other users that also access the Internet, and each of these relationships can define a social affinity group of the user. As used in this specification, a “social affinity group” of a user is a group to which the user and other users belong by a defined relationship. Each user can be a member of multiple social affinity groups, and each social affinity group is known by a search system and is regarded as an independent whole separate from other social affinity groups.

The relationships between users that establish each group can be of a predefined type and can be implicit or explicit. Explicit relationships are identified by the user, e.g., friends, family, business, or other connections established by the user. Implicit relationships (e.g., common demographic, the same city, etc.) can be identified by the search system with permission of the user. Whether implicit or explicit, the relationship of the social affinity group identifies the group of users and the user as a proper subset of users of a network.

Examples of groups identified by explicit relationships include users belonging to a “friends lists” of a user in a social network, users that are “linked to” a user in a professional network, and users that otherwise explicitly identify themselves as belonging to a group so as to form a group that is distinct from the larger group of all users. Examples of groups identified by implicit relationships include users located near a common location, e.g., users within a predefined distance of a city center, users that have opined on a particular product or article, e.g., users that have provided a review for a particular product, and users that are otherwise implicitly identified so as to form a group that is distinct from the larger group of all users.

As described above, users may endorse resources, and in particular, images. One common way that many users receive images over the Internet is by use of a search system. As will be described in more detail below, the systems and methods of this application enable users to endorse images at both an image search result level and image resource level.

Endorsing an image at the image search result level involves a user indicating one of a positive or negative endorsement of a representative image in an image search result when interacting with the image search result. As used herein, an image search result is data returned by a search system in response to a search query and that identifies an image determined to be responsive to the search query. The image search result typically includes a representative image that depicts an actual image the search system has determined to be responsive to the query. For example, a representative image may be a cropped version of an image, or scaled or re-sized version of an image, such as a thumbnail. The image search result also includes a hyperlink to the image (e.g., a hyperlink to the web page in which the image is included, or perhaps a link to the actual image itself).

Endorsing an image at the image resource level involves a user indicating one of a positive or negative endorsement of the actual image displayed in a web page. The web page in which the image is displayed is not a search results page; instead, the web page is, for example, a web page referenced by the image search result and that includes the actual image represented by the representative image of the image search result.

The search system is configured to annotate image search results with the endorsements of other users that belong to a requesting user's social affinity group(s). Accordingly, when a user receives image search results, the user can see that other users with whom the user has a relationship have endorsed the image.

The processing of the endorsements by the search system and the presentation of the endorsements is described in more detail below.

Example Environment

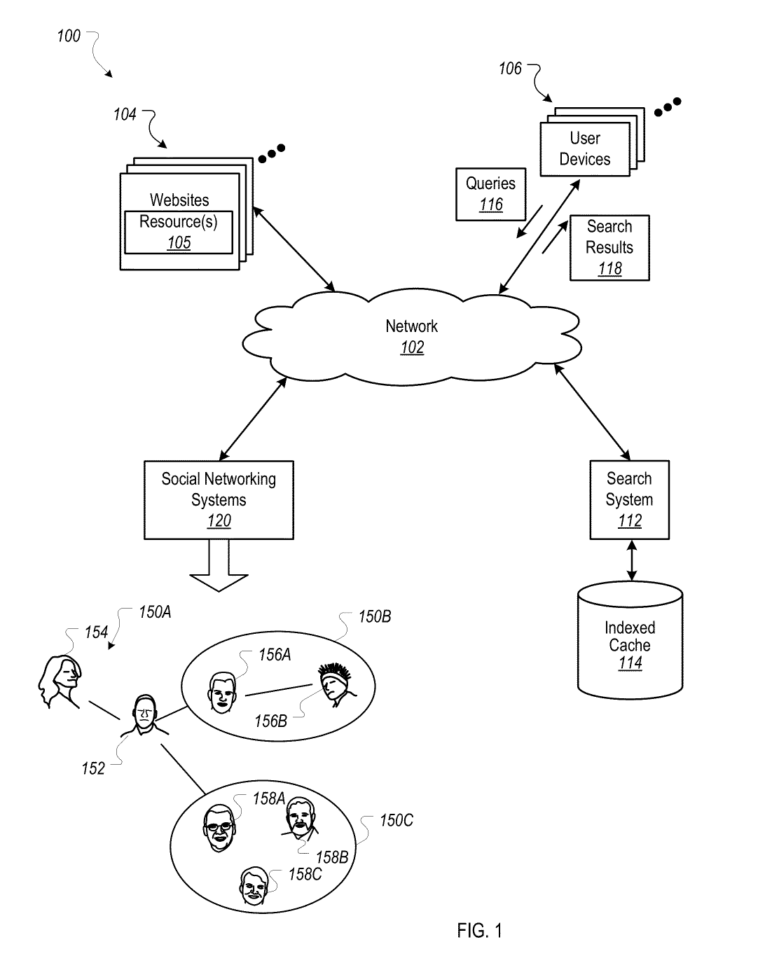

FIG. 1 is a block diagram of an example environment 100 in which image endorsements in image search results are provided. The example environment 100 includes one or more social networking systems 120 that allow users to interact with other users within a social framework. A network 102, such as a local area network (LAN), a wide area network (WAN), the Internet, or a combination thereof, connects websites 104, user devices 106, a search system 112, and social networking systems 120.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, images, portable document format (PDF) documents, videos, and feed sources, to name only a few.

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106.

To facilitate searching of these resources 105, a search system 112 identifies the resources 105 by crawling and indexing the resources provided by the content publishers of the websites 104. Data about the resources 105 can be indexed based on the resource to which the data corresponds. The indexed and, optionally, cached copies of the resources 105 can be stored in an indexed cache 114.

For images, the search system 112 utilizes image processing algorithms to identify multiple instances of the same image. The search system 112, in some implementations, then selects a representative image (e.g., a canonical image) that is used to represent each of the identical images, and associates the representative image with each of the underlying identical images. The underlying web page that is referenced in the image search result is determined at query time, as a particular query may include information that results in one particular web page being selected over other web pages that include the same image.

In some implementations, the search system 112 also identifies images that are derived from the same source image. For example, scale invariant feature transform (SIFT), edge detection, interest point detection, pixel matching, and other appropriate image processing techniques can be used to identify identical images and images that are derived from a same source image (e.g., thumbnails of an image, cropped versions of an image, color and hue adjusted versions of an image, etc.). A representative image (or set of representative images) is then selected by the image search system 112.

In additional implementations, a representative image can also be representative of a cluster of similar images. For example, clustering techniques, such as feature distance clustering, agglomerative clustering, etc., can be used to group similar images. For each group, a representative image is selected.

At query time, the user devices 106 submit search queries 116 to the search system 112 over the network 102. In response, the search system 112 accesses the indexed cache 114 to identify resources 105 that are relevant to the search query 116. The search system 112 identifies the resources 105 in the form of search results 118 and returns the search results 118 to the user devices 106 in search results pages.

The social networking systems 120 provide functions and tools for users to establish relationships with other users. For example, for the user 152, the social affinity group 150A of the user 152 includes the user 152, and a first friend 154 identified by the user 152. The user 152 can identify the first friend 154 in, for example, a user profile. The social affinity group 150B of the user 152 includes the user 152 and family members 156A and 156B. Finally, the social affinity group 150C includes the user 152 and a group of co-workers 158A, 158B and 158C.

In operation, the search system 112 provides, with each image search result, a control by which a user can provide an endorsement of the image. The endorsements for each particular representative image are associated with an image identifier of the representative image. Likewise, in some implementations, when a user navigates to a web page (e.g., clicks on an image search result or simply inputs a URL into a browser address bar) that includes an actual image represented by the representative image, and the user then endorses the actual image displayed on the web page, the search system 112 aggregates the endorsement up to the representative image. In this way, each time a user endorses the representative image, or an actual image represented by the representative image, the endorsements are aggregated at the representative image level so that a cumulative endorsement count can be provided. This cumulative count can be provided with the representative image, and, in some implementations, with each image represented by the representative image.

Example User Interface Features

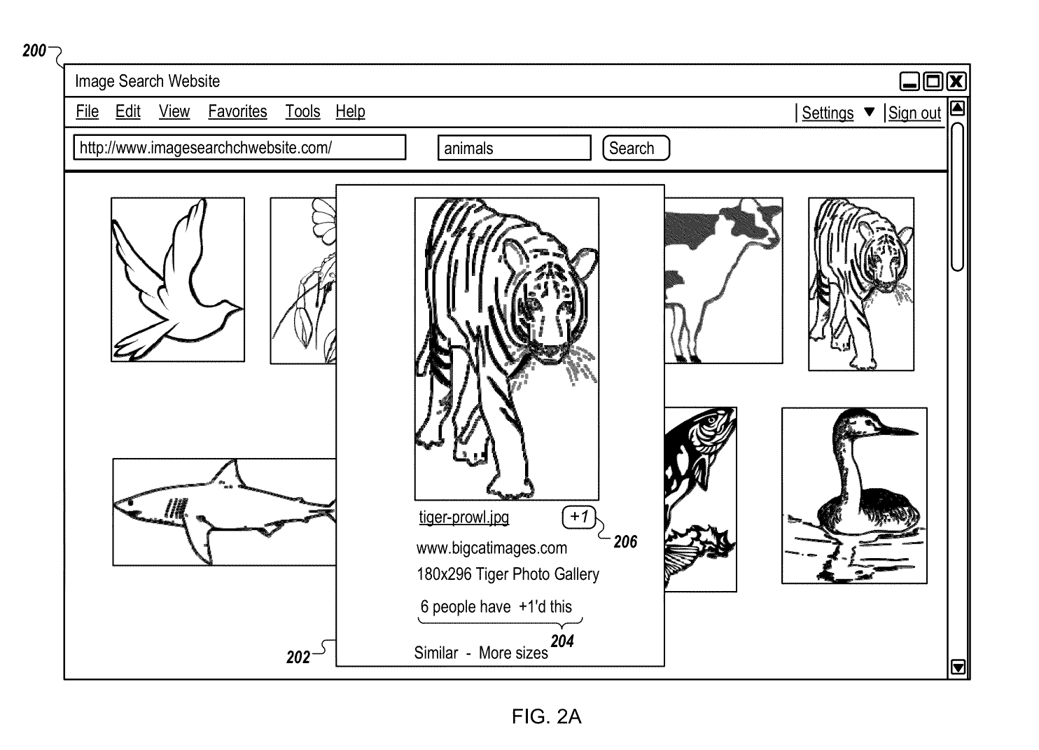

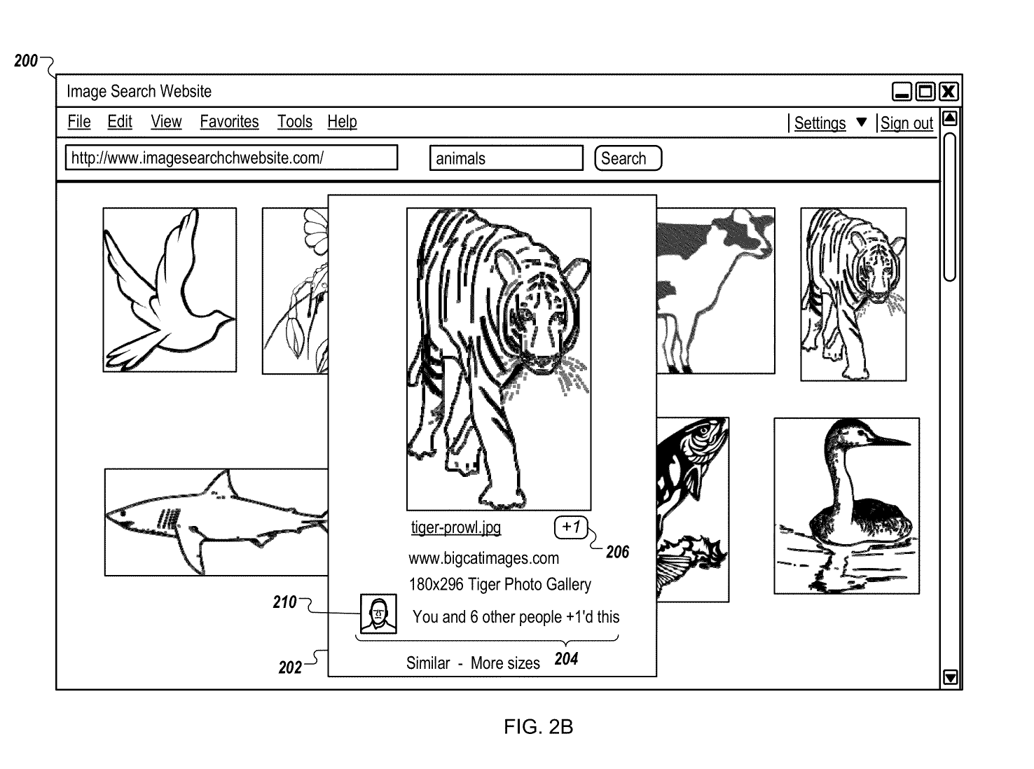

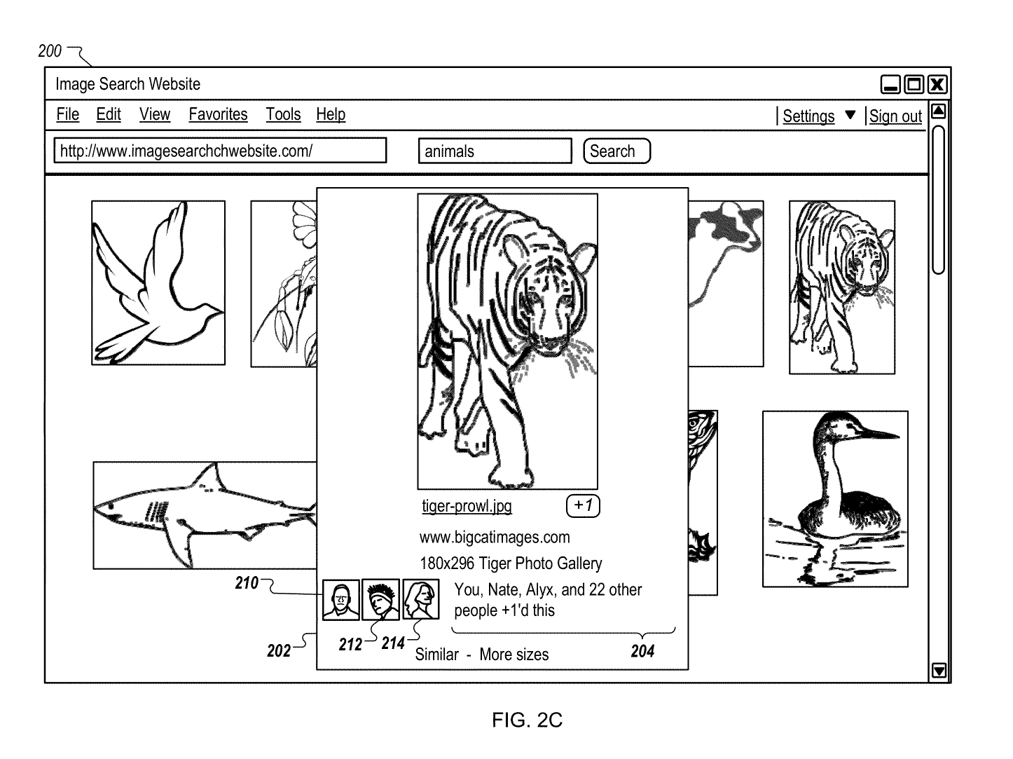

Example user interface that includes an image with endorsement data and a control for endorsing the image are described with reference to FIGS. 2A-2C. For example, FIG. 2A shows an example user interface 200 that includes an image 202 with an annotation 204 and a control 206 for endorsing the image 202. A user can use the control 206 to endorse the image.

The user interface 200 can be provided, for example, by the search system 112 of FIG. 1. The image 202 is a representative image for an image search result that is served in response to an image search query issued by a user. In some implementations, the annotation 204 describes endorsements of the image 202 (e.g., endorsement of the representative image or the actual image(s) the representative image represents) by users that belong to a social affinity group to which the user belongs. In the example shown in FIG. 2A, the annotation 204 states that “6 people have +1'd this,” meaning that six people in that belong to the same social affinity group(s) as the user have positively endorsed the image 202. Other example types of information that the annotation 204 can provide include the number of members in the user's groups who endorsed the image, the name of a user's friend who liked the image 202, and so on.

FIG. 2B shows another view of the example user interface 200 that includes the image 202. In the illustrated example, the user has endorsed the image 202. For example, the user has clicked, pressed, selected, or otherwise activated the control 206. In response to the clicking of the control 206, the user device 106 transmits data to the search system 112 that associates with the image 202 an endorsement of the image 202 by the user. Accordingly, the social affinity groups to which the user belongs are also associated with the image 202. Additionally, in the example shown in FIG. 2B, the annotation 204 now states that “You and 6 other people have +1'd this,” meaning that the user and the six other people have endorsed the image 202.

The annotation 204, in some implementations, also includes an image thumbnail 210. The image thumbnail 210 can be an image associated with the user's social network profile. For example, the image thumbnail 210 can be a photo that the user has provided, a default image provided by the social networking system 120, or an image placeholder.

FIG. 2C shows another view of the example user interface 200 that includes the image 202. In the illustrated example, the user, as well as several other members of the user's social network have “plus +1'd” the image 202, and the annotation 204 is updated to indicate the addition endorsements associated with the image 202.

The annotation 204 also includes the image thumbnail 210, as well as an image thumbnail 212 and an image thumbnail 214. The image thumbnails 212 and 214 are images associated with the social network profiles of the other users in the user's social affinity groups who have also endorsed the image 202. In some implementations, the number of image thumbnails displayed in association with the annotation 204 may be limited to a predetermined maximum number of image thumbnails. In the illustrated example, there is only space sufficient for the display of three image thumbnails 210, 212, and 214. In some implementations, the image thumbnails 212 and 214 may be selected to represent the other users who have endorsed the image 202 and also have the greatest social affinity to the user.

In some implementations, more than one type of annotation may be applied to an image. For example, if the user belongs to several social affinity groups (e.g., as shown in FIG. 1), the search system 112 can generate annotation data describing the endorsement association with the users and the social affinity groups to which the users belong by generating annotation data describing an aggregate number of endorsements for each social affinity group. For example, the annotation may state “Three colleagues in your work circle endorsed this image, and two members of your family in your family circle endorsed this image.” In some implementations, the annotation may include a link for each aggregated endorsement group, and selection of the link causes the annotation to change to include information regarding the endorsements from the aggregated endorsement group.

In some implementations, if more than one type of annotation is to be applied to an image, the user interface 200 can cycle between the different annotations. For example, a first annotation may state that three colleagues in the user's work circle endorsed the image, and may include thumbnail links to the profile pages of each of the coworkers, and a second annotation may state that two members of the user's family circle endorsed the image, and may include thumbnail links to the profile pages of each of family members.

Providing annotations based on the endorsement associations of members of a requesting user's social affinity groups can be facilitated by other appropriate methods.

Processing Received Endorsements

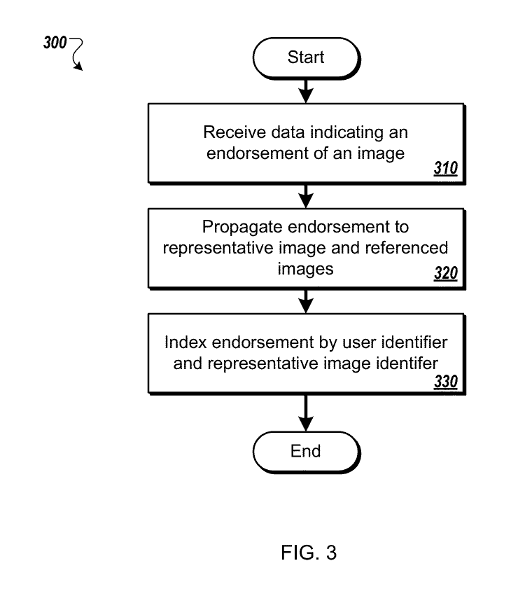

FIG. 3 is a flowchart of an example process 300 for processing an endorsement for an image. The process 300 can be implemented in a data processing apparatus, e.g., one or more computers that are in data communication.

Endorsement data indicating an endorsement of an image is received (310). For example, a user that is logged into an account associated with the search system 112 and/or a social network 120 may endorse an image. The image that is endorsed, for example, may be a representative image in an image search result, or, alternatively, may be an image presented on a web page and that is not a search result. The endorsement data may also include a user identifier, such as the user's account identifier of an account on the social network and/or the search system.

The endorsement data are propagated to the representative image and referenced images (320). For example, when the image that is endorsed is the representative image in an image search result, then the endorsement is associated with each image the representative image represents, e.g., each instance of the image hosted by the websites 104 that the search system 112 has discovered. On the other hand, when the image that is endorsed is an image presented on a web page and that is not a search result and that the search system 112 has associated with the representative image (e.g., an actual image that the representative image represents), then the endorsement is associated with the representative image.

The endorsement data are indexed by the user identifier and the representative image identifier (330). For example, each user's endorsement of a particular image is indexed by that user's identifier and the representative image identifier. By doing so, the search system 112 and/or the social network 120 can determine, for any requesting user, whether any other users that belong to the same social affinity group have endorsed a particular image. If so, then the search system 112 can generate annotation data for presentation to the user.

Generating and Providing Annotations from Endorsements

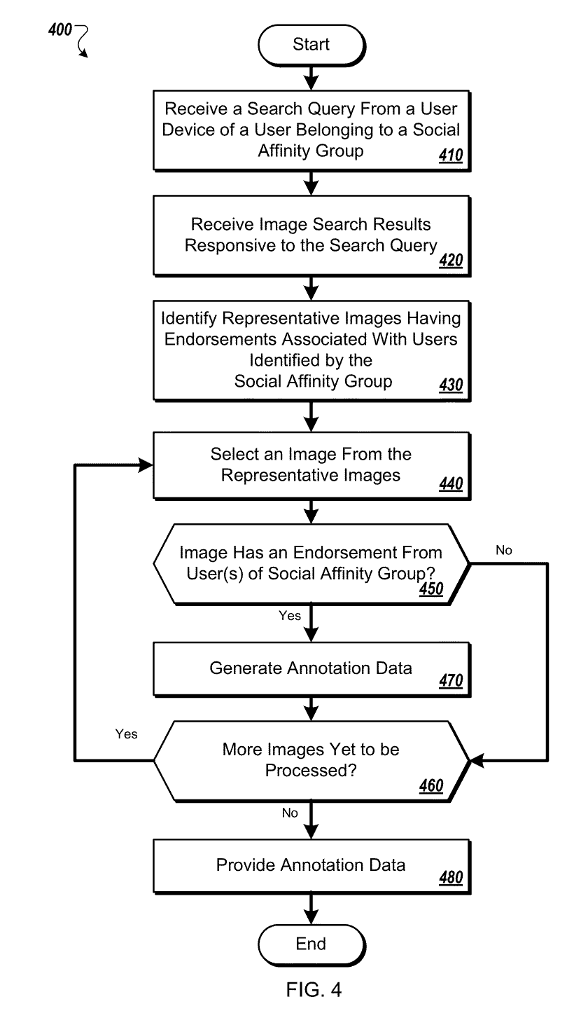

FIG. 4 is a flowchart of an example process 400 for providing annotations based on endorsements. The process 400 can be performed, for example, by the search system 112, and can be used to generate the user interfaces described with reference to FIGS. 2A-2C.

A search query is received from a user device of a user (410). The user belongs to a social affinity group, such as a social group or social circle. The social affinity group identifies a group of users and the user as a proper subset of users of a network. For example, the social network can include a number of users, while the social affinity group can identify the users of the network with whom the user has a social relationship. As described above, the user may belong to multiple different social affinity groups.

Image search results are received that are responsive to the search query (420). Each image search result references a corresponding image resource that is determined to be responsive to the search query. For example, the image 202 is a search result that represents an image indexed by the search system 112. Each image search result also includes a representative image of the image resource, and the representative image has a corresponding image identifier by which the representative image is indexed in a search system. For example, the image 202 can be a scaled version of an original image. The original image can also be associated with an identifier that uniquely identifies the original image in the search system 112.

Representative images of the image search results that each have an endorsement association with one or more of the users identified by the social affinity group are identified (430). For example, in the example of FIG. 2B, the image 202 has been endorsed (e.g., “plus +1'd,”) by the user and six other users that belong to the same social affinity group.

For each search result that includes a representative image having an endorsement association with one or more of the users identified by the social affinity group, annotation data is generated describing the endorsement association with at least one of the users identified by the social affinity group (440-460). For example, an image is selected from the representative images (440). If the image is determined to not have an endorsement (450), then no annotation is generated and the next image, if any, will be selected (460).

If, on the other hand, the image is determined (450) to have an endorsement from a user of the social affinity group, then annotation data is generated (470). For example, the identity of endorsing users or the identities of social circles associated with endorsing users may be generated (470) as annotation data.

If more images are determined (460) as yet remaining to be processed, then another image is selected (440) from the representative images. If no more images are determined (460) to remain, then the annotation data is provided (480) to a user device for presentation with the representative image. For example, the annotation can be presented as depicted and described with reference to FIGS. 2A-2C.

Additional Features and Variations

In some implementations, each user can specify, by means of an access control list, whether endorsements may be made available to other users that do not belong to a user's social affinity group. Such endorsements are “public endorsements,” and the user's identity is not revealed. Accordingly, only an aggregate endorsement count is presented with the representative image.

In some implementations, endorsement may be publicly presented as a total aggregate endorsement count in addition to endorsements by others in a user's social affinity group. The endorsements may include endorsements for other social affinity groups that the user does not necessarily belong to. For example, an annotation may state “434 People +1'd this image, 6 People in your friends circle +1'd this image.” Thus, of the 434 endorsements, six came from a particular user's social affinity group.

In additional implementations, endorsements of similar images can be attributed to a representative image. For example, each representative image can be provided with an unfiltered cumulative endorsement count that is an aggregation of all endorsements for each image belonging to a cluster that the representative image represents. For example, the annotation may include text such as “3,500 people have +1'd this image or images like this image” or “3,500 people, including you, have +1'd this image or images like this image.”

In some implementations, images that are subject to an access control list may only be shown to others on the access control list so as to prevent data leakage when examining a user's endorsement history. For example, a user profile of a user may make available, at the user's option, all images a user has endorsed. However, if a particular image is not publicly available (e.g., family photos stored on-line), then this portion of the user's endorsement history is not disclosed publicly. Instead, the portion of the user's endorsement history pertaining to an image subject to an access control list is only made available to other users on the access control list.

Other appropriate access control methods and data leakage prevention techniques can also be used.

In some implementations, the endorsement information is used by the search system to adjust the ranking of image search results. For example, an image search result that many other users that belong to a particular user's social affinity group(s) have endorsed may be boosted in a search result ranking relative to an image search result that few or no other users that belong to a particular user's social affinity group(s) have endorsed. In variations of this implementation, a user may select which social affinity groups are used to provide endorsement data, e.g., a user, when conducting scholarly research, may decide that only endorsements from the user's “University Professors” social affinity group may be used. Conversely, the same user, when selecting a locale for a family reunion, may decide that only endorsements from the user's “Family Members” social affinity group may be used.

Additional Aspects

Methods, systems and apparatus that embody the subject matter described above may include one or more of the following aspects. An aspect includes receiving a search query from a user device of a user, the user belonging to a social affinity group, the social affinity group identifying a group of users and the user as a proper subset of users of a network; receiving image search results responsive to the search query, each image search result referencing a corresponding image resource that is determined to be responsive to the search query and including a representative image of the image resource, the representative image having a corresponding image identifier by which the representative image is indexed in a search system; identifying representative images of the image search results that each have an endorsement association with one or more of the users identified by the social affinity group; for each image search result that includes a representative image having an endorsement association with one or more of the users identified by the social affinity group, generating annotation data describing the endorsement association with at least one of the users identified by the social affinity group; and providing the annotation data to a user device for presentation with the representative image.

An additional aspect that can be in combination with the aspect above is wherein the endorsement association with one or more users specifies, for each of the one or more users, an endorsement of the representative image by the user.

An additional aspect that can be in combination with one or more of the aspects above is wherein the endorsement association with one or more users specifies a cumulative endorsement count of endorsements of the representative image by the one or more users.

An additional aspect that can be in combination with one or more of the aspects above is wherein the annotation data comprises a hyperlink to a user profile of a user identified by the social affinity group.

An additional aspect that can be in combination with one or more of the aspects above is wherein: each representative image is representative of one or more image resources, each of the one or more image resources being image data derived from a same image; and further comprising, for each of the image resources: attributing, to the image resource, the endorsement association of the representative image that represents the image resource, and in response to a request for the image resource from the user device, generating annotation data describing the endorsement association with at least one of the users identified by the social affinity group and that is attributed to the image resource, and providing the annotation data to the user device for presentation with the image resource.

An additional aspect that can be in combination with one or more of the aspects above is wherein the social affinity group is one of a plurality of social affinity groups to which the user belongs, and each social affinity group includes a different proper subset of users of a network, identifying representative images of the image search results that each have an endorsement association with one or more of the users identified by the social affinity group comprises identifying endorsement associations with users of each social affinity group; and generating annotation data describing the endorsement association with at least one of the users identified by the social affinity group comprises generating annotation data describing the endorsement association with the users and the social affinity groups to which the users belong.

An additional aspect that can be in combination with one or more of the aspects above is wherein generating annotation data describing the endorsement association with the users and the social affinity groups to which the users belong comprises generating annotation data describing an aggregate number of endorsements for each social affinity group.

An additional aspect that can be in combination with one or more of the aspects above is wherein the representative image is provided to the user device for presentation when the user has permission to view the representative image, and an image placeholder is provided to the user device for presentation when the user does not have permission to view the representative image.

An additional aspect that can be in combination with one or more of the aspects above is wherein each representative image is representative of one or more image resources, each of the one or more image resources belonging to a cluster of similar images; and further comprising, for each of the image resources: attributing, to the image resource, the endorsement associating of the representative image that represents the image resource; and in response to a request for the image resource from the user device: generating annotation data describing the endorsement association with at least one of the users identified by the social affinity group and that is attributed to the image resource; and providing the annotation data to the user device for presentation with the image resource.

Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by a data processing apparatus, the method comprising:
receiving a search query from a user device of a user, the user belonging to a social affinity group, the social affinity group identifying a group of users and the user as a proper subset of users of a network;
receiving image search results responsive to the search query, each image search result referencing a corresponding image resource that is determined to be responsive to the search query and including a representative image of the image resource, the representative image having a corresponding image identifier by which the representative image is indexed in a search system;
identifying representative images of the image search results that each have an endorsement association with one or more of the users identified by the social affinity group;
for each image search result that includes a representative image having an endorsement association with one or more of the users identified by the social affinity group, generating annotation data describing the endorsement association with at least one of the users identified by the social affinity group; and
providing the annotation data to a user device for presentation with the representative image.

2. The method of claim 1, wherein the endorsement association with one or more users specifies, for each of the one or more users, an endorsement of the representative image by the user.

3. The method of claim 1, wherein the endorsement association with one or more users specifies a cumulative endorsement count of endorsements of the representative image by the one or more users.

4. The method of claim 1, wherein the annotation data comprises a hyperlink to a user profile of a user identified by the social affinity group.

5. The method of claim 1, wherein:
each representative image is representative of one or more image resources, each of the one or more image resources being image data derived from a same image; and
further comprising, for each of the image resources:
attributing, to the image resource, the endorsement association of the representative image that represents the image resource; and
in response to a request for the image resource from the user device:
generating annotation data describing the endorsement association with at least one of the users identified by the social affinity group and that is attributed to the image resource; and
providing the annotation data to the user device for presentation with the image resource.

6. The method of claim 1, wherein:
the social affinity group is one of a plurality of social affinity groups to which the user belongs, and each social affinity group includes a different proper subset of users of a network;
identifying representative images of the image search results that each have an endorsement association with one or more of the users identified by the social affinity group comprises identifying endorsement associations with users of each social affinity group;
generating annotation data describing the endorsement association with at least one of the users identified by the social affinity group comprises generating annotation data describing the endorsement association with the users and the social affinity groups to which the users belong.

7. The method of claim 6, wherein generating annotation data describing the endorsement association with the users and the social affinity groups to which the users belong comprises generating annotation data describing an aggregate number of endorsements for each social affinity group.

8. The method of claim 1, wherein:
the representative image is provided to the user device for presentation when the user has permission to view the representative image, and an image placeholder is provided to the user device for presentation when the user does not have permission to view the representative image.

9. The method of claim 1, wherein:
each representative image is representative of one or more image resources, each of the one or more image resources belonging to a cluster of similar images; and
further comprising, for each of the image resources:
attributing, to the image resource, the endorsement associating of the representative image that represents the image resource; and
in response to a request for the image resource from the user device:
generating annotation data describing the endorsement association with at least one of the users identified by the social affinity group and that is attributed to the image resource; and
providing the annotation data to the user device for presentation with the image resource.

10. A system, comprising:
a data processing apparatus; and
a non-transitory memory storage storing instructions executable by the data processing apparatus and that upon such execution cause the data processing apparatus to perform operations comprising:
receiving a search query from a user device of a user, the user belonging to a social affinity group, the social affinity group identifying a group of users and the user as a proper subset of users of a network;
receiving image search results responsive to the search query, each image search result referencing a corresponding image resource that is determined to be responsive to the search query and including a representative image of the image resource, the representative image having a corresponding image identifier by which the representative image is indexed in a search system;
identifying representative images of the image search results that each have an endorsement association with one or more of the users identified by the social affinity group;
for each image search result that includes a representative image having an endorsement association with one or more of the users identified by the social affinity group, generating annotation data describing the endorsement association with at least one of the users identified by the social affinity group; and
providing the annotation data to a user device for presentation with the representative image.

11. The system of claim 10, wherein the endorsement association with one or more users specifies, for each of the one or more users, an endorsement of the representative image by the user.

12. The system of claim 10, wherein:
each representative image is representative of one or more image resources, each of the one or more image resources being image data derived from a same image; and
the operations further comprise, for each of the image resources:
attributing, to the image resource, the endorsement association of the representative image that represents the image resource; and
in response to a request for the image resource from the user device:
generating annotation data describing the endorsement association with at least one of the users identified by the social affinity group and that is attributed to the image resource; and
providing the annotation data to the user device for presentation with the image resource.

13. The system of claim 10, wherein:
the social affinity group is one of a plurality of social affinity groups to which the user belongs, and each social affinity group includes a different proper subset of users of a network;
identifying representative images of the image search results that each have an endorsement association with one or more of the users identified by the social affinity group comprises identifying endorsement associations with users of each social affinity group;
generating annotation data describing the endorsement association with at least one of the users identified by the social affinity group comprises generating annotation data describing the endorsement association with the users and the social affinity groups to which the users belong.

14. The system of claim 13, wherein generating annotation data describing the endorsement association with the users and the social affinity groups to which the users belong comprises generating annotation data describing an aggregate number of endorsements for each social affinity group.

15. A non-transitory computer readable medium storing instructions executable by a data processing apparatus and that upon such execution cause the data processing apparatus to perform operations comprising:
receiving a search query from a user device of a user, the user belonging to a social affinity group, the social affinity group identifying a group of users and the user as a proper subset of users of a network;
receiving image search results responsive to the search query, each image search result referencing a corresponding image resource that is determined to be responsive to the search query and including a representative image of the image resource, the representative image having a corresponding image identifier by which the representative image is indexed in a search system;
identifying representative images of the image search results that each have an endorsement association with one or more of the users identified by the social affinity group;
for each image search result that includes a representative image having an endorsement association with one or more of the users identified by the social affinity group, generating annotation data describing the endorsement association with at least one of the users identified by the social affinity group; and
providing the annotation data to a user device for presentation with the representative image.

16. The computer readable medium of claim 15, wherein the endorsement association with one or more users specifies, for each of the one or more users, an endorsement of the representative image by the user.

17. The computer readable medium of claim 15, wherein:
each representative image is representative of one or more image resources, each of the one or more image resources being image data derived from a same image; and
the operations further comprise, for each of the image resources:
attributing, to the image resource, the endorsement association of the representative image that represents the image resource; and
in response to a request for the image resource from the user device:
generating annotation data describing the endorsement association with at least one of the users identified by the social affinity group and that is attributed to the image resource; and
providing the annotation data to the user device for presentation with the image resource.

18. The computer readable medium of claim 15, wherein:
the social affinity group is one of a plurality of social affinity groups to which the user belongs, and each social affinity group includes a different proper subset of users of a network;
identifying representative images of the image search results that each have an endorsement association with one or more of the users identified by the social affinity group comprises identifying endorsement associations with users of each social affinity group;
generating annotation data describing the endorsement association with at least one of the users identified by the social affinity group comprises generating annotation data describing the endorsement association with the users and the social affinity groups to which the users belong.

19. The computer readable medium of claim 15, wherein generating annotation data describing the endorsement association with the users and the social affinity groups to which the users belong comprises generating annotation data describing an aggregate number of endorsements for each social affinity group.
